(19) United States
(12) Patent Application Publication
(10) Pub. No.: US 2014/0170960 A1
(43) Pub. Date: Jun. 19, 2014

(54) Hole Sealing Device For The Front Face Of A Motor Vehicle

(71) Applicant: Frederic Vacca, Behoust (FR)

(72) Inventor: Frederic Vacca, Behoust (FR)

(21) Appl. No.: 14/233,795

(22) PCT Filed: Jul. 20, 2012
(86) PCT No.: PCT/EP2012/064360

§ 371 Date: Jan. 20, 2014

(30) Foreign Application Priority Data
Jul. 21, 2011 (FR) 1156644

(51) Int. Cl. B60K 11/08

(52) U.S. Cl. CPC B60K 11/085
USPC 454/333

(57) ABSTRACT

The present invention concerns a hole sealing device (1) in particular for a main air inlet in the front face of a motor vehicle, comprising:—a support frame (5) comprising at least one shutter (3) pivoting about a pivot pin (A) between an open position and a closed position,—at least one pivot rod (7), said at least one shutter (3) having a link pin (B) linking it with said pivot rod (7),—at least one actuator (9) for moving the pivot rod (7) and controlling the position of the at least one shutter (3), said at least one shutter (3) being linked to a resilient opening means (15) at least comprising a mobile part (151), a resilient member (152) and a retaining member (153) for said resilient member (152).

The present invention relates to hole sealing devices and more precisely a hole sealing device for the front face of a motor vehicle.

The front faces of motor vehicles are generally composed of two main air inlets which are referred to as the upper channel and lower channel and which are separated by means of a shock-absorption beam. The heat exchangers of the motor vehicle are generally placed behind this shock-absorption beam, such as, for example, the heat exchanger used for the air conditioning of the passenger space or the one used for cooling the engine.

It is also known to arrange, in the path of air which passes via the main air inlets, more generally the lower channel, a support frame which comprises a multiplicity of flaps which are pivotably mounted about parallel axes and which are capable of assuming a multiplicity of different angular positions, between an open position and a closed position, under the action of appropriate control means.

There is thus obtained a device which resembles a shutter member which allows the flow of air flowing through the air inlets and arriving at the heat exchangers to be adjusted and thus enables the efficiency of these heat exchangers to be optimized in accordance with requirements. Furthermore, at high speed, the flaps in a closed position allow the drag coefficient of the vehicle to be reduced and thus allow the aerodynamics thereof to be improved.

Generally, the device which allows movement from a closed position to an open position of the flaps comprises an actuator which may be mechanical, electrical or pneumatic, causing the flaps to pivot in a synchronized manner using a pivoting connecting rod.

In a closed position and under travel conditions, the flaps are subjected to the air pressure which is a result of the speed of the vehicle and which is applied over the entire surface thereof. In this manner, they are configured to resist pressure originating from the speed of the vehicle added to an extreme wind speed if the vehicle is travelling against the wind, consequently increasing the air pressure applied to the flaps.

To this end, the flaps have appropriate surfaces, thicknesses and geometries and are produced from materials which are capable of withstanding such stresses.

However, these stresses are generally calculated in accordance with a fluid which is air having a density of 1.2 kg/m³, but the stresses become greater as the density of the fluid increases. In this manner, in the case of off-road vehicles which travel through fords or which travel through a significant puddle of water, the fluid pressing against the flaps is water having a density of 1000 kg/m³. The permissible stresses for the flaps are therefore very quickly exceeded and they may become damaged or even break. It is thus known, in order to prevent the flaps from becoming damaged, to greatly reduce the travel speed through water. For example, for an off-road vehicle passing through a ford which has a water level of from 200 to 350 mm, the manufacturers impose an approach speed of 50 km/h with a constant passage speed of from 15 to 20 km/h. However, it is not always easy for the driver to assess these passage speeds.

One of the objects of the invention is therefore to at least partially overcome the disadvantages of the prior art and to provide a flap device which enables at least partial freedom from the limitation of the speed of the vehicle, in particular for passing through water.

The invention therefore relates to a hole sealing device, in particular for a main air inlet of the front face of a motor vehicle, comprising:
a support frame which comprises at least one flap which pivots about a pivot axis between an open position and a closed position,
at least one pivot connecting rod, the at least one flap having a connection axis with respect to the pivot connecting rod,
at least one actuator which is for moving the pivot connecting rod and which controls the positioning of the at least one flap,
   the at least one flap being connected to a resilient opening means which comprises at least one movable portion, a resilient element and an element for retaining the resilient element, allowing the flap to be at least partially opened in the event of a stress greater than the compression resistance of the resilient element.

According to one aspect of the invention, the resilient opening means is placed in a housing of the pivot connecting rod and the movable portion of the resilient opening means is connected to the flap in the region of the connection axis.

According to another aspect of the invention, the at least one flap which is connected to a resilient opening means is an asymmetrical flap.

According to another aspect of the invention, the resilient element is a spring.

According to another aspect of the invention, the sealing device comprises at least one group of flaps which comprise(s) a plurality of parallel rows of flaps.

According to another aspect of the invention, the at least one flap which is connected to at least one resilient opening means belongs to the lower row.

According to another aspect of the invention, the sealing device comprises two groups of flaps which are positioned at each side of a control element which contains the actuator and the pivot connecting rod.

The invention also relates to a front face of a motor vehicle which comprises a sealing device comprising:
a support frame which comprises at least one flap which pivots about a pivot axis between an open position and a closed position,
at least one pivot connecting rod, the at least one flap having a connection axis with respect to the pivot connecting rod,
at least one actuator which is for moving the pivot connecting rod and which controls the positioning of the at least one flap,
   the at least one flap being connected to a resilient opening means which comprises at least one movable portion, a resilient element and an element for retaining the resilient element, which allows the flap to be at least partially opened in the event of a stress greater than the compression resistance of the resilient element.

According to another aspect of the invention, the sealing device is placed on the lower air inlet channel of the front face of a motor vehicle.

Other features and advantages of the invention will be appreciated more clearly from a reading of the following description, given by way of non-limiting example, and the appended drawings, in which:

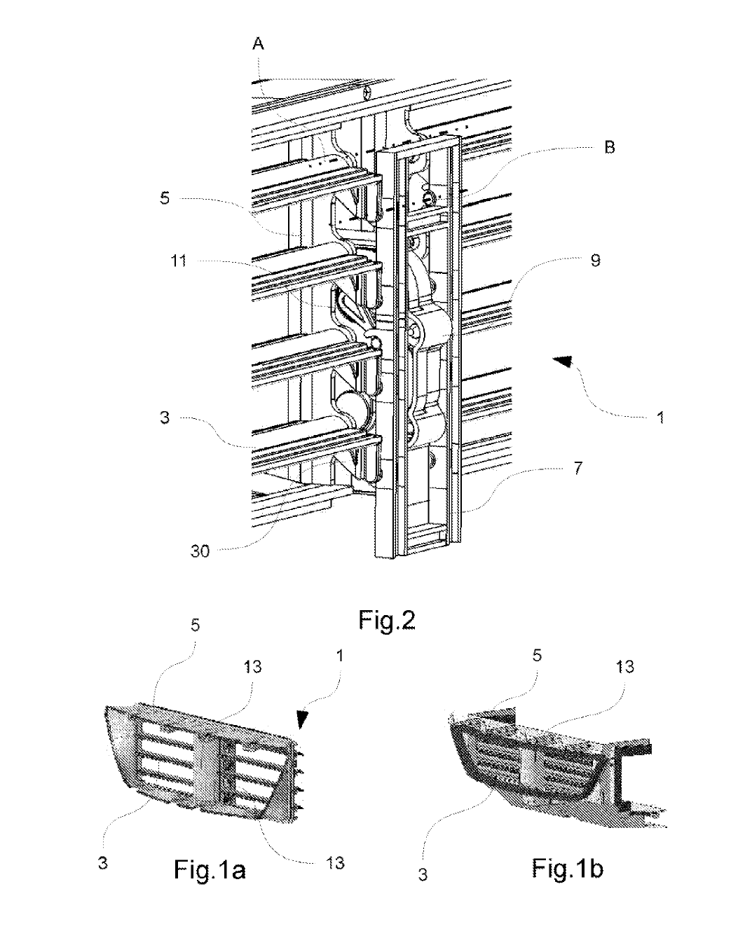

FIGS. 1a and 1b are perspective views of a portion of the front face of a motor vehicle comprising a sealing device in an open position and in a closed position, respectively,

FIG. 2 is a schematic view of the mechanism of the sealing device,

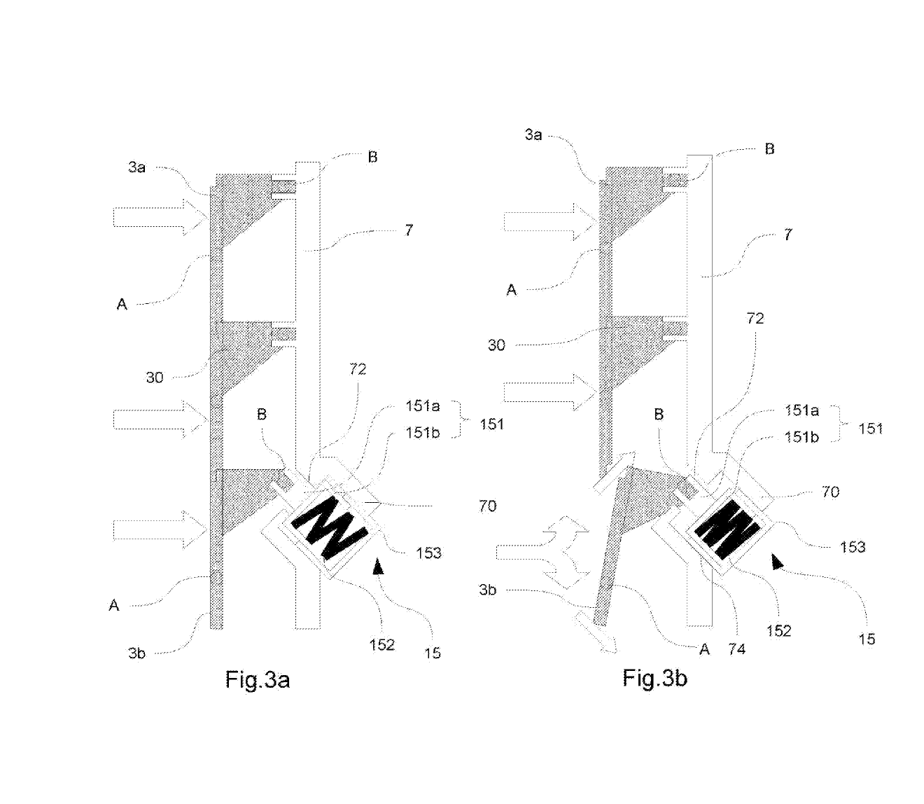

FIGS. 3a and 3b are schematic side views of a sealing device in the closed position with and without the action of a resilient opening means, respectively.

Elements which are identical in the different figures have the same reference numerals.

FIGS. 1a and 1b are perspective views of a front face of a motor vehicle comprising a sealing device 1 in an open position.

The sealing device 1 comprises a support frame 5 on which there are installed two groups of flaps 3 which form parallel rows of flaps 3, in an open position. The two groups of flaps 3 are separated from each other by a control element 13 which contains, as illustrated in FIG. 2, a pivot connecting rod 7 which is connected to the flaps 3 by means of a rib 30 which is perpendicular relative to the flap 3, which is generally integral with the flap 3 and which has a connection axis B.

The control element 13 also comprises an actuator 9. The actuator 9 may be electrical, such as, for example, an electric motor, pneumatic, such as, for example, a jack, or mechanical. The actuator applies an upward or downward movement to the pivot connecting rod 7, in this instance by means of a lever 11.

The flaps 3 may pivot about a pivot axis A which is defined by their connection to the support frame 5. Since the connection axis B between the flaps 3 and the connecting rod 7 is eccentric with respect to the pivot axis A, an upward or downward movement of the connecting rod 7 under the action of the actuator 9 brings about the pivoting of the flaps about the pivot axis A and therefore the movement of the flaps into the closed position, as shown in FIG. 1b, or into an open position, as shown in FIG. 1a.

Since all the flaps 3 are connected to the same pivot connecting rod 7, the movement from an open position to a closed position is synchronous for all the flaps 3. It is also possible for the groups to comprise only a single flap 3.

Without departing from the scope of the invention, it is also possible to have a hole sealing device 1 for the front face of a motor vehicle which comprises only a single group of flaps 3 which extends over the entire width of the support frame 5 and which comprises a control element 13 at one of the sides of the support frame 5 or two synchronous control elements 13 which are located at each side of the support frame 5.

It is also possible to have a sealing device 1 comprising several groups of flaps 3, each one individually controlled by one or more control elements 13.

FIGS. 3a and 3b show in greater detail the connection between the flaps 3a and 3b and the pivot connecting rod 7 and the connection between at least one flap 3b and a resilient opening means 15.

The pivot connecting rod 7 comprises at least one housing 70 in which a resilient opening means 15 is inserted. The resilient opening means 15 comprises an element 151 which can be moved in translation and which comprises a first portion 151a having a diameter smaller than a second portion 151b. The resilient opening means also comprises a resilient element 152 for compression resistance and an element 153 for retaining the resilient element 152.

The housing 70 of the connecting rod 7 comprises a hole 72 through which the first portion 151a of the movable element 151 extends in order to be able to be connected to the connection axis B of the flap 3b, the diameter of the hole 72 being smaller than that of the second portion 152b of the movable element 151 so that the second portion 151b is blocked in the housing 70.

The housing 70 of the connecting rod 7 also comprises a hole 74 which is opposite the hole 72 and in which the retention element 153 is inserted in a static manner in terms of translation. For example, the retention element 153 may be clip-fitted or screwed in the hole 74, thus closing the housing 70.

Inside the housing 70, the resilient element 152 of the resilient opening means 15 is located between the movable element 151 and the retention element 153. The resilient element 152 which is resistant to compression and which is supported on the retention element 153 and applies to the movable element 151 a force which pushes it away from the retention element 153.

As shown in FIG. 3a, in the closed position, the resilient opening means 15, as a result of the compression resistance of the resilient element 152, allows the flap 3b to be kept in the closed position, in spite of a pressure stress to which the flaps 3a, 3b are subjected and which is applied by a fluid, for example, air, under travel conditions.

However, if the pressure applied to the flap 3a by the fluid is greater than the compression resistance of the resilient element 152, the resilient element 152 becomes compressed and the movable portion 151 is inserted in the housing 70, which allows the flap 3b to pivot about the pivot axis A thereof and to half-open. The fluid can then pass via the partial openings produced by the pivoting action of the flap 3b and thus the pressure applied to the flaps can decrease, which protects them from potential breakage.

The resilient element 152 may be, for example, a spring and has a compression resistance which is sufficient to withstand “normal” stresses to which the sealing device 1 is subjected. This is intended to be understood to mean that the resilient element 152 is compressed only for stresses greater than the stresses originating from the maximum speed of the vehicle added to an extreme wind speed if the vehicle were travelling against the wind.

The opening of the flap 3b connected to the resilient opening means 15 is made possible by the fact that the flap 3b is asymmetrical, that is to say, its pivot axis A is not centered and therefore the portions at one side and the other of its pivot axis A do not have an equal surface-area. In this manner, the portion of the flap 2b which carries the rib 30 and which is therefore connected to the resilient opening means 15 has a greater surface area than the portion of the flap 3b which is located at the other side of the pivot axis A. The portion of the flap 3b is consequently subjected to a greater pressure, in a closed position, than the other portion and therefore allows the opening movement to be initiated. In the case of symmetrical flaps 3a, that is to say, in which the portions of the flap 3a have the same surface-area, the surface pressure for each portion is identical and is therefore balanced, which prevents the pivoting of the flap 3a under the action of pressure stresses.

Preferably, the flap(s) 3b which is/are connected to a resilient opening means 15 are flaps 3b which belong to the lower rows of a flap group 3 which is located at the lower air supply channel of a front face of the motor vehicle, that is to say, which are closest to the ground. It is these lower rows which are the most likely to be immersed and to be subjected to high levels of stresses when an off-road vehicle passes through a ford or crosses a large puddle of water.

It can thus be seen clearly that the sealing device 1 according to the invention, in the case of significant stresses applied to the flaps 3, allows these stresses to be reduced as a result of one or more resilient opening means 15 and thus allows the integrity of the flaps 3 to be preserved. Furthermore, it also allows at least partial freedom from the speed limitations advised for passage through water, such as passing through a ford.

1. A hole sealing device, for a main air inlet of the front face of a motor vehicle, comprising:
a support frame which comprises at least one flap which pivots about a pivot axis (A) between an open position and a closed position,
at least one pivot connecting rod, the at least one flap having a connection axis (B) with respect to the pivot connecting rod,
at least one actuator which is for moving the pivot connecting rod and which controls the positioning of the at least one flap,
wherein the at least one flap is connected to a resilient opening means which comprises at least one movable portion, a resilient element and an element for retaining the resilient element, which allows the flap to be at least partially opened in the event of a stress greater than the compression resistance of the resilient element.

2. The sealing device as claimed in claim 1, wherein the resilient opening means is placed in a housing of the pivot connecting rod and wherein the movable portion of the resilient opening means is connected to the flap in the region of the connection axis (B).

3. The sealing device as claimed in claim 2, wherein the at least one flap which is connected to the resilient opening means is an asymmetrical flap.

4. The sealing device as claimed in claim 1, wherein the resilient element is a spring.

5. The sealing device as claimed in claim 1, wherein the sealing device comprises at least one group of flaps which comprise(s) a plurality of parallel rows of flaps.

6. The sealing device as claimed in claim 5, wherein the at least one flap which is connected to the at least one resilient opening means belongs to the lower row.

7. The sealing device as claimed in claim 5, wherein the sealing device comprises two groups of flaps which are positioned at each side of a control element which contains the actuator and the pivot connecting rod.

8. A front face of a motor vehicle which comprises a sealing device comprising:
a support frame which comprises at least one flap which pivots about a pivot axis (A) between an open position and a closed position,
at least one pivot connecting rod, the at least one flap having a connection axis (B) with respect to the pivot connecting rod,
at least one actuator which is for moving the pivot connecting rod and which controls the positioning of the at least one flap,
wherein the at least one flap is connected to a resilient opening means which comprises at least one movable portion, a resilient element and an element for retaining the resilient element, which allows the flap to be at least partially opened in the event of a stress greater than the compression resistance of the resilient element as claimed in claim 1.

9. The front face of a motor vehicle as claimed in claim 8, wherein the sealing device is placed on the lower air inlet channel of the front face of a motor vehicle.

10. The sealing device as claimed in claim 2, wherein the resilient element is a spring.

11. The sealing device as claimed in claim 3, wherein the resilient element is a spring.

12. The sealing device as claimed in claim 2, wherein the sealing device comprises at least one group of flaps which comprise(s) a plurality of parallel rows of flaps.

13. The sealing device as claimed in claim 3, wherein the sealing device comprises at least one group of flaps which comprise(s) a plurality of parallel rows of flaps.

14. The sealing device as claimed in claim 4, wherein the sealing device comprises at least one group of flaps which comprise(s) a plurality of parallel rows of flaps.
